(19) United States
(12) Patent Application Publication
(10) Pub. No.: US 2014/0336849 A1
(43) Pub. Date: Nov. 13, 2014

(54) SYSTEM AND METHOD FOR DISPLAYING RATE-OF-CLIMB ON AN AVIONICS VERTICAL SPEED INDICATOR

(71) Applicant: HONEYWELL INTERNATIONAL INC., Morristown, NJ (US)

(72) Inventors: Mallikarjun Bhimashankar K, Indi (IN); Dilip Kumar Behara, Bangalore (IN); Ravindra Jayaprakash, Bangalore (IN)

(73) Assignee: Honeywell International Inc., Morristown, NJ (US)

(21) Appl. No.: 13/889,887

(22) Filed: May 8, 2013

(51) Int. Cl. G01P 3/62

(52) U.S. Cl. CPC G01P 3/62
USPC 701/4

(57) ABSTRACT

A system and method are providing for providing an aircraft with adequate clearance over an obstacle in the aircraft's takeoff departure path. The correct rate-of-climb to clear the obstacle is determined in a processor; for example a TOLD system. The result is then rendered on a display for viewing prior to takeoff.

### TECHNICAL FIELD

Embodiments disclosed herein relate generally to avionics display systems and, more particularly, to a system and method for displaying rate-of-climb on a vertical speed indicator.

### BACKGROUND

Runways with obstacles in their departure paths may be challenging because steep rates of climb may be necessary to clear the obstacles. Pilots may not be aware of the climb gradients or how to calculate the rate-of-climb. While current display systems do show the vertical speed on, for example, the Vertical Speed Indicator (VSI) of a Primary Flight Display (PFD), they do not show the target rate-of-climb that must be achieved by the aircraft in order to safely clear the obstacles in the path of the departing aircraft during takeoff.

In view of the foregoing, it would be desirable to provide a system and method for displaying the required rate-of-climb on, for example, the VSI on a PFD, during the takeoff phase of a flight, thus reducing pilot workload by eliminating the necessity to refer to various charts and tables and then calculating the target rate-of-climb.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In accordance with the foregoing, there is provided a method for enhancing situational awareness onboard an aircraft during a takeoff procedure comprising rendering on a display a rate-of-climb suitable for avoiding an obstacle in the takeoff path of an aircraft.

A flight deck display system is also provided in accordance with a further embodiment. It comprises a source of data related to an obstacle in an aircraft's departure path, a display system, and a processor coupled to the source of data and to the display system and configured to render on the display a rate-of-climb adequate to avoid the obstacle.

In accordance with a still further embodiment, there is provided a method for providing an aircraft with adequate clearance over an obstacle in the aircraft's takeoff departure path, comprising determining in a processor the correct rate-of-climb to clear the obstacle, rendering the rate-of-climb on a display for viewing prior to takeoff,

### BRIEF DESCRIPTION OF THE DRAWINGS

FIG. 1 is a block diagram of an exemplary embodiment of an aircraft display system;

FIG. 2 is a diagram illustrating a runway, an aircraft, an obstacle, and the parameters that must be considered during takeoff to avoid the obstacle;

FIG. 3 is a graphical representation of a vertical speed indicator having a target rate-of-climb rendered thereon; and

FIG. 4 is a flow-chart illustrating a method for displaying the target rate-of-climb in accordance with an embodiment.

### DETAILED DESCRIPTION

The following detailed description is merely exemplary in nature and is not intended to limit the subject matter of the application and uses thereof. Furthermore, there is no intention to be bound by any theory presented in the preceding background or the following detailed description. Presented herein for purposes of explication is a certain exemplary embodiment of how a rate-of-climb, suitable for avoiding an obstacle in the takeoff path of an aircraft, may be displayed onboard the aircraft. As such, the examples presented herein are intended as non-limiting.

Techniques and technologies may be described herein in terms of functional and/or logical block components and with reference to symbolic representations of operations, processing tasks, and functions that may be performed by various computing components or devices. It should be appreciated that any number of hardware, software, and/or firmware components configured to perform the specified functions may realize the various block components shown in the figures. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

The system and methods described herein can be deployed with vehicles, such as aircraft, spacecraft, and the like. The preferred embodiments of the system and methods described herein represent an intelligent way to present visual airport information related to runway obstacles in the departure path to a pilot or flight crew during operation of the aircraft and, in particular, during takeoff.

For the sake of brevity, conventional techniques related to graphics and image processing, navigation, flight planning, aircraft controls, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

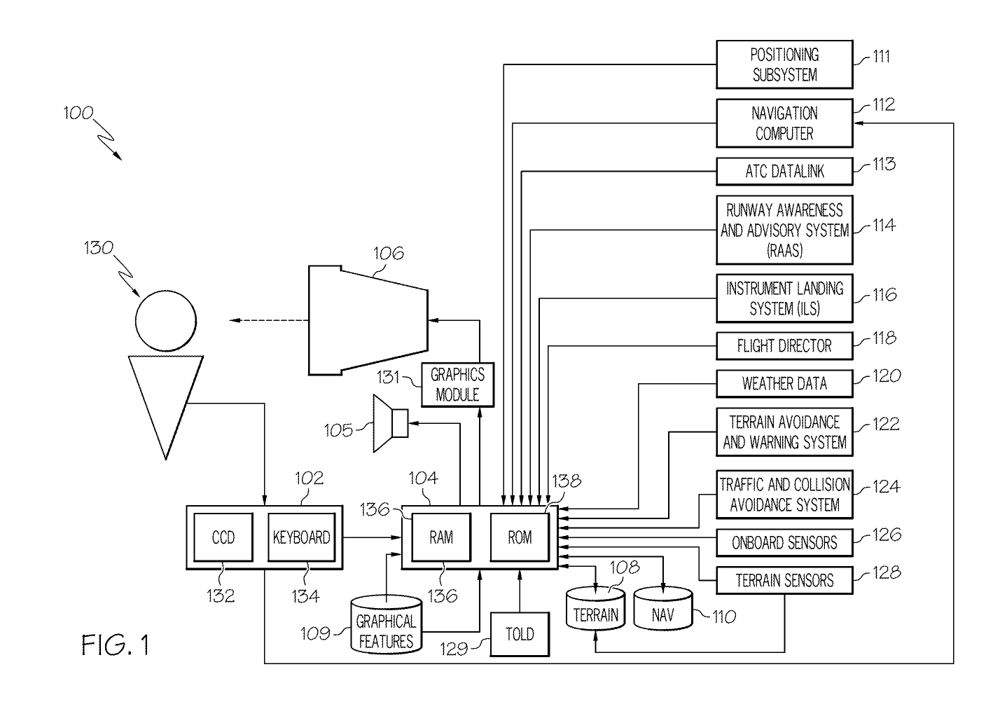

Turning now to the drawings, FIG. 1 depicts an exemplary flight deck display system 100 (suitable for a vehicle such as an aircraft) that generally includes, without limitation: a user interface 102; a processor architecture 104 coupled to the user interface 102; an aural annunciator 105; and a display element 106 coupled to the processor architecture 104. The system 100 may also include, cooperate with, and/or communicate with a number of databases, sources of data, or the like. Moreover, the system 100 may include, cooperate with, and/or communicate with a number of external subsystems as described in more detail below. For example, the processor architecture 104 may cooperate with one or more of the following components, features, data sources, and subsystems, without limitation: one or more terrain databases 108; one or more graphical features databases 109; one or more navigation databases 110; a positioning subsystem 111; a navigation computer 112; an air traffic control (ATC) data link subsystem 113; a runway awareness and advisory system (RAAS) 114; an instrument landing system (ILS) 116; a flight director 118; a source of weather data 120; a terrain avoidance and warning system (TAWS) 122; a traffic and collision avoidance system (TCAS) 124; one or more onboard sensors 126; one or more terrain sensors 128; and takeoff and landing data 129.

The user interface 102 is in operable communication with the processor architecture 104 and is configured to receive input from a user 130 (e.g., a pilot) and, in response to the user input, supply command signals to the processor architecture 104. The user interface 102 may be any one, or combination, of various known user interface devices including, but not limited to, a cursor control device (CCD) 132, such as a mouse, a trackball, or joystick, one or more buttons, switches, or knobs. In the depicted embodiment, the user interface 102 includes the CCD 132 and a keyboard 134. The user 130 manipulates the CCD 132 to, among other things, move cursor symbols that might be rendered at various times on the display element 106, and the user 130 may manipulate the keyboard 134 to, among other things, input textual data. As depicted in FIG. 1, the user interface 102 may also be utilized to enable user interaction with the navigation computer 112, the flight management system, and/or other features and components of the aircraft.

The processor architecture 104 may utilize one or more known general-purpose microprocessors or an application specific processor that operates in response to program instructions. In the depicted embodiment, the processor architecture 104 includes or communicates with onboard RAM (random access memory) 136, and onboard ROM (read only memory) 138. The program instructions that control the processor architecture 104 may be stored in either or both the RAM 136 and the ROM 138. For example, the operating system software may be stored in the ROM 138, whereas various operating mode software routines and various operational parameters may be stored in the RAM 136. It will be appreciated that this is merely exemplary of one scheme for storing operating system software and software routines, and that various other storage schemes may be implemented. It will also be appreciated that the processor architecture 104 may be implemented using various other circuits, not just a programmable processor. For example, digital logic circuits and analog signal processing circuits could also be used.

The processor architecture 104 is in operable communication with the terrain database 108, the graphical features database 109, the navigation database 110, and the display element 106, and is coupled to receive various types of data, information, commands, signals, etc., from the various sensors, data sources, instruments, and subsystems described herein. For example, the processor architecture 104 may be suitably configured to obtain and process real-time aircraft status data (e.g., avionics-related data) as needed to generate a graphical synthetic perspective representation of terrain in a primary display region. The aircraft status or flight data may also be utilized to influence the manner in which graphical features (associated with the data maintained in the graphical features database 109) of a location of interest such as an airport are rendered during operation of the aircraft. For the exemplary embodiments described here, the graphical features database 109 may be considered to be a source of airport feature data that is associated with synthetic graphical representations of one or more airport fields.

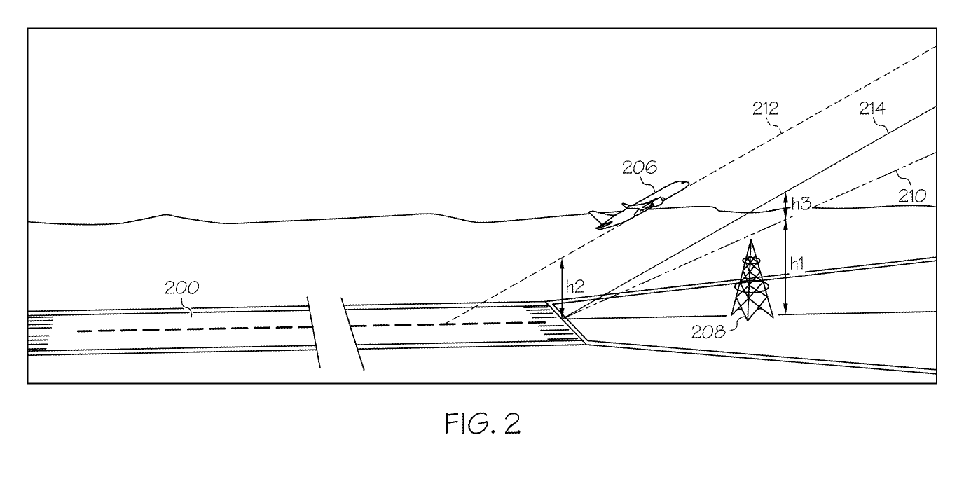

For this embodiment, the graphical features database 109 is an onboard database that contains pre-loaded airport feature data including geo-referenced runway features such as runway obstacles. In alternate embodiments, some or all of the airport feature data can be loaded into the graphical features database 109 during flight. Indeed, some airport feature data could be received by the aircraft in a dynamic manner as needed. The airport feature data accessed by the processor architecture 104 is indicative of displayable visual features of one or more airports of interest. In practice, the airport feature data can be associated with any viewable portion, aspect, marking, structure, building, geography, and/or landscaping located at, on, in, or near an airport including any obstacles that may require special takeoff parameters. Depending on the particular airport field, the airport feature could be related to any of the following obstacles including, without limitation, buildings, mountains, structures, towers, light poles power lines, telephone poles, antennas, and the like, in the takeoff path of an aircraft located at or near the airport. The processing and rendering of the airport feature data will be described in more detail below in connection with FIGS. 2-4.

In certain embodiments, the processor architecture 104 is configured to respond to inertial data obtained by the onboard sensors 126 to selectively retrieve terrain data from the terrain database 108 or the terrain sensor 128, to selectively retrieve navigation data from the navigation database 110, and/or to selectively retrieve graphical features data from the graphical features database 109, where the graphical features data corresponds to the location or target of interest. The processor architecture 104 can also supply appropriate display commands (e.g., image rendering display commands) to the display element 106, so that the retrieved terrain, navigation, and graphical features data are appropriately displayed on the display element 106. Processor architecture 104 also provides appropriate commands to aural annunciator 105 (e.g. aural alert generating commands. The processor architecture 104 may be further configured to receive real-time (or virtually real-time) airspeed, altitude, attitude, waypoint, and/or geographic position data for the aircraft and, based upon that data, generate image rendering display commands associated with the display of terrain.

The display element 106 is used to display various images and data, in both a graphical and a textual format, and to supply visual feedback to the user 130 in response to the user input commands supplied by the user 130 to the user interface 102. It will be appreciated that the display element 106 may be any one of numerous known displays suitable for rendering image and/or text data in a format viewable by the user 130. Non-limiting examples of such displays include various cathode ray tube (CRT) displays, and various flat panel displays such as, various types of LCD (liquid crystal display), OLED, and TFT (thin film transistor) displays. The display element 106 may additionally be based on a panel mounted display, a HUD projection, or any known technology. In an exemplary embodiment, the display element 106 includes a panel display, and the display element 106 is suitably configured to receive image rendering display commands from the processor architecture 104 and, in response thereto, the display element 106 renders a synthetic graphical display having a perspective view corresponding to a flight deck viewpoint. In certain situations, the display element 106 receives appropriate image rendering display commands and, in response thereto, renders a synthetic representation of an airport field. The graphically rendered airport field might include conformal graphical representations of taxiways, runways, and signage rendered on the taxiways. To provide a more complete description of the operating method that is implemented by the flight deck display system 100, a general description of exemplary displays and various graphical features rendered thereon will be provided below with reference to FIGS. 2-4.

As FIG. 1 shows, the processor architecture 104 is in operable communication with the source of weather data 120, the TAWS 122, and the TCAS 124, and is additionally configured to generate, format, and supply appropriate display commands to the display element 106 so that the avionics data, the weather data 120, data from the TAWS 122, data from the TCAS 124, and data from the previously mentioned external systems may also be selectively rendered in graphical form on the display element 106. The data from the TCAS 124 can include Automatic Dependent Surveillance Broadcast (ADS-B) messages.

The terrain database 108 includes various types of data, including elevation data, representative of the terrain over which the aircraft is flying. The terrain data can be used to generate a three dimensional perspective view of terrain in a manner that appears conformal to the earth. In other words, the display emulates a realistic view of the terrain from the flight deck or cockpit perspective. The data in the terrain database 108 can be pre-loaded by external data sources or provided in real-time by the terrain sensor 128. The terrain sensor 128 provides real-time terrain data to the processor architecture 104 and/or the terrain database 108. In one embodiment, terrain data from the terrain sensor 128 is used to populate all or part of the terrain database 108, while in another embodiment, the terrain sensor 128 provides information directly, or through components other than the terrain database 108, to the processor architecture 104.

In another embodiment, the terrain sensor 128 can include visible, low-light TV, infrared, or radar-type sensors that collect and/or process terrain data. For example, the terrain sensor 128 can be a radar sensor that transmits radar pulses and receives reflected echoes, which can be amplified to generate a radar signal. The radar signals can then be processed to generate three-dimensional orthogonal coordinate information having a horizontal coordinate, vertical coordinate, and depth or elevation coordinate. The coordinate information can be stored in the terrain database 108 or processed for display on the display element 106.

In one embodiment, the terrain data provided to the processor architecture 104 is a combination of data from the terrain database 108 and the terrain sensor 128. For example, the processor architecture 104 can be programmed to retrieve certain types of terrain data from the terrain database 108 and other certain types of terrain data from the terrain sensor 128. In one embodiment, terrain data retrieved from the terrain sensor 128 can include moveable terrain, such as mobile buildings and systems. This type of terrain data is better suited for the terrain sensor 128 to provide the most up-to-date data available. For example, types of information such as water-body information and geopolitical boundaries can be provided by the terrain database 108. When the terrain sensor 128 detects, for example, a water-body, the existence of such can be confirmed by the terrain database 108 and rendered in a particular color such as blue by the processor architecture 104.

The navigation database 110 includes various types of navigation-related data stored therein. In preferred embodiments, the navigation database 110 is an onboard database that is carried by the aircraft. The navigation-related data include various flight plan related data such as, for example, and without limitation: waypoint location data for geographical waypoints; distances between waypoints; track between waypoints; data related to different airports; navigational aids; obstructions; special use airspace; political boundaries; communication frequencies; and aircraft approach information. In one embodiment, combinations of navigation-related data and terrain data can be displayed. For example, terrain data gathered by the terrain sensor 128 and/or the terrain database 108 can be displayed with navigation data such as waypoints, airports, etc. from the navigation database 110, superimposed thereon.

Although the terrain database 108, the graphical features database 109, and the navigation database 110 are, for clarity and convenience, shown as being stored separate from the processor architecture 104, all or portions of these databases 108, 109, 110 could be loaded into the onboard RAM 136, stored in the ROM 138, or integrally formed as part of the processor architecture 104. The terrain database 108, the graphical features database 109, and the navigation database 110 could also be part of a device or system that is physically separate from the system 100.

The positioning subsystem 111 is suitably configured to obtain geographic position data for the aircraft. In this regard, the positioning subsystem 111 may be considered to be a source of geographic position data for the aircraft. In practice, the positioning subsystem 111 monitors the current geographic position of the aircraft in real-time, and the real-time geographic position data can be used by one or more other subsystems, processing modules, or equipment on the aircraft (e.g., the navigation computer 112, the RAAS 114, the ILS 116, the flight director 118, the TAWS 122, or the TCAS 124). In certain embodiments, the positioning subsystem 111 is realized using global positioning system (GPS) technologies that are commonly deployed in avionics applications. Thus, the geographic position data obtained by the positioning subsystem 111 may represent the latitude and longitude of the aircraft in an ongoing and continuously updated manner.

The avionics data that is supplied from the onboard sensors 126 includes data representative of the state of the aircraft such as, for example, aircraft speed, altitude, attitude (i.e., pitch and roll), heading, groundspeed, turn rate, etc. In this regard, one or more of the onboard sensors 126 may be considered to be a source of heading data for the aircraft. The onboard sensors 126 can include MEMS-based, ADHRS-related or any other type of inertial sensor. As understood by those familiar with avionics instruments, the aircraft status data is preferably updated in a continuous and ongoing manner.

The weather data 120 supplied to the processor architecture 104 is representative of at least the location and type of various weather cells. The data supplied from the TCAS 124 includes data representative of other aircraft in the vicinity, which may include, for example, speed, direction, altitude, and altitude trend. In certain embodiments, the processor architecture 104, in response to the TCAS data, supplies appropriate display commands to the display element 106 such that a graphic representation of each aircraft in the vicinity is displayed on the display element 106. The TAWS 122 supplies data representative of the location of terrain that may be a threat to the aircraft. The processor architecture 104, in response to the TAWS data, preferably supplies appropriate display commands to the display element 106 such that the potential threat terrain is displayed in various colors depending on the level of threat. For example, red is used for warnings (immediate danger), yellow is used for cautions (possible danger), and green is used for terrain that is not a threat. It will be appreciated that these colors and number of threat levels are merely exemplary, and that other colors and different numbers of threat levels can be provided as a matter of choice.

As was previously alluded to, one or more other external systems (or subsystems) may also provide avionics-related data to the processor architecture 104 for display on the display element 106. In the depicted embodiment, these external systems include a flight director 118, an instrument landing system (ILS) 116, runway awareness and advisory system (RAAS) 114, and navigation computer 112. The flight director 118, as is generally known, supplies command data representative of commands for piloting the aircraft in response to flight crew entered data, or various inertial and avionics data received from external systems. The command data supplied by the flight director 118 may be supplied to the processor architecture 104 and displayed on the display element 106 for use by the user 130, or the data may be supplied to an autopilot (not illustrated). The autopilot, in turn, produces appropriate control signals that cause the aircraft to fly in accordance with the flight crew entered data, or the inertial and avionics data.

The ILS 116 is a radio navigation system that provides the aircraft with horizontal and vertical guidance just before and during landing and, at certain fixed points, indicates the distance to the reference point of landing. The system includes ground-based transmitters (not shown) that transmit radio frequency signals. The ILS 116 onboard the aircraft receives these signals and supplies appropriate data to the processor for display.

The RAAS 114 provides improved situational awareness to help lower the probability of runway incursions by providing timely aural advisories to the flight crew during taxi, takeoff, final approach, landing and rollout. The RAAS 114 uses GPS data to determine aircraft position and compares aircraft position to airport location data stored in the navigation database 110 and/or in the graphical features database 109. Based on these comparisons, the RAAS 114, if necessary, issues appropriate aural advisories. Aural advisories, which may be issued by the RAAS 114, inform the user 130, among other things of when the aircraft is approaching a runway, either on the ground or from the air at times such as when the aircraft has entered and is aligned with a runway, when the runway is not long enough for the particular aircraft, the distance remaining to the end of the runway as the aircraft is landing or during a rejected takeoff, when the user 130 inadvertently begins to take off from a taxiway, and when an aircraft has been immobile on a runway for an extended time. During approach, data from sources such as GPS, including RNP and RNAV, can also be considered.

The navigation computer 112 is used, among other things, to allow the user 130 to program a flight plan from one destination to another. The navigation computer 112 may be in operable communication with the flight director 118. As was mentioned above, the flight director 118 may be used to automatically fly, or assist the user 130 in flying, the programmed route. The navigation computer 112 is in operable communication with various databases including, for example, the terrain database 108 and the navigation database 110. The processor architecture 104 may receive the programmed flight plan data from the navigation computer 112 and cause the programmed flight plan, or at least portions thereof, to be displayed on the display element 106.

The ATC datalink subsystem 113 is utilized to provide air traffic control data to the system 100, preferably in compliance with known standards and specifications. Using the ATC datalink subsystem 113, the processor architecture 104 can receive air traffic control data from ground based air traffic controller stations and equipment. In turn, the system 100 can utilize such air traffic control data as needed. For example, taxi maneuver clearance may be provided by an air traffic controller using the ATC datalink subsystem 113.

In operation, a flight deck display system as described herein is suitably configured to process the current real-time geographic position data, the current real-time heading data, the airport feature data, and possibly other data to generate image rendering display commands for the display element 106. Thus, the synthetic graphical representation of an airport field rendered by the flight deck display system will be based upon or otherwise influenced by at least the geographic position and heading data and the airport feature data.

Takeoff and Landing Data (TOLD) system 129 is coupled to processor 104 and computes the V-speeds for takeoff and landing, where V1 is the Go/No Go speed, VR is the rotation speed, V2 is the takeoff safety speed, VAPP is the approach speed, and VREF is the takeoff reference speed. These are typically depicted on the airspeed tape of the PFD, but the rate-of-climb required for takeoff is not. As will be further described below, the TOLD system does provide a climb gradient for a particular runway that may then be converted to the rate-of-climb.

Instrument departure procedures have been developed, the primary purpose of which is to provide obstacle clearance. Runways that have obstacles in their departure path are particularly challenging during takeoff due to the steep rate-of-climb that must be achieved to avoid the obstacle. LaGuardia Airport in New York City is one of the more challenging due to the many obstacles in the departure paths. These departure procedures must be carefully reviewed by a pilot in order to identify the rate-of-climb necessary for obstacle clearance. This adds considerably to pilot workload adding to the challenge, especially when climbing at night or during instrument meteorological conditions.

The departure procedure usually contains ceiling and visibility requirements. For example, the runway (Rwy) 1L/1R of KLAS—Las Vegas—MCCARRAN NTL Departure Procedure indicates a ceiling of 1200 feet, a visibility of three miles, and a minimum climb rate of 410 feet per nautical mile (NM) to 5000 feet. The minimum climb of 410 feet/NM is required because of an obstacle at 3189 feet Mean Sea Level (MSL) at 2.93 NM North. This can be in the departure procedure for KLAS or provided by the TOLD system.

FIG. 2 illustrates a runway 200 having a departure end 202 and is useful for describing (1) the design criteria associated with an example departure procedure; and (2) the goal of displaying the rate-of-climb in accordance with an embodiment. Also shown in FIG. 2 is an aircraft 206 taking off from runway 200 along a climb path over an obstacle 208. As can be seen, the Obstacle Clear Surface (OCS) is represented by line 210 at an altitude of h1 (e.g. 152 feet) and at a distance of one nautical mile from the departure end 202 of the runway 200. Obstacle clearance is based on the assumption that aircraft 206 crosses the departure end 202 of the runway at a predetermined altitude h2 (e.g. 35 feet) and climb at a predetermined V1 (e.g. 200 feet) per nautical mile. This is represented by line 212 in FIG. 2. When obstacles penetrate the OCS, a higher climb gradient is required. For example, in Las Vegas, the departure chart for KLAS dictates a climb rate of 410 feet per nautical mile. Any climb rate exceeding the standard rate-of-climb of 152 feet per nautical mile represents a challenge for pilots. Still referring to FIG. 2, line 214 represents the climb path of aircraft 206 that has crossed the departure end 202 of runway 200 and has a rate-of-climb equal to the required climb gradient of 200 feet per NM passing over obstacle 208 at a height h3 (i.e. 48 feet).

Embodiments described herein dramatically reduce pilot workload associated with high-gradient take-offs requiring obstacle clearances. This is accomplished by eliminating the need to refer to various charts and tables to calculate the necessary rate-of-climb. In accordance with an embodiment, this may be accomplished by graphically displaying a rate-of-climb value required for takeoff on the Vertical Speed Indicator (VSI) scale of, for example, a Primary Flight Display. This, in turn, is accomplished by converting the climb gradient (e.g. generated by a TOLD system 129) into a rate-of-climb value, and displaying the result on display 106 (FIG. 1), e.g. a Primary Flight Display.

First, a processor 104 or TOLD system 129 generates a climb gradient based on obstacles in the departure path. This may be accomplished using data from a TOLD system 129 (FIG. 1), currently installed on most business, general, and regional aircraft or a processor 104. When a TOLD system is employed, the pilot may input the obstacle distance and obstacle elevation into processor 104 via, for example, user interface 102 or, a page of the multi-functional display unit. Next, the processor 104 or TOLD unit (if used) converts the climb gradient in feet per NM to rate-of-climb in feet per minute. For example, if the aircraft speed is 120 knots and the TOLD system computed climb gradient is 410 feet/NM, then the rate-of-climb is: 410 ft/NM (120 knots)=410 ft/NM (120 NM/hr)=410 ft/NM (120 NM/60 min)=410 ft/m (2) =820 ft/min. This rate-of-climb is supplied to graphics module 131 which renders, on display 106 (e.g. the VSI scale of a PFD) the required rate-of-climb just prior to takeoff

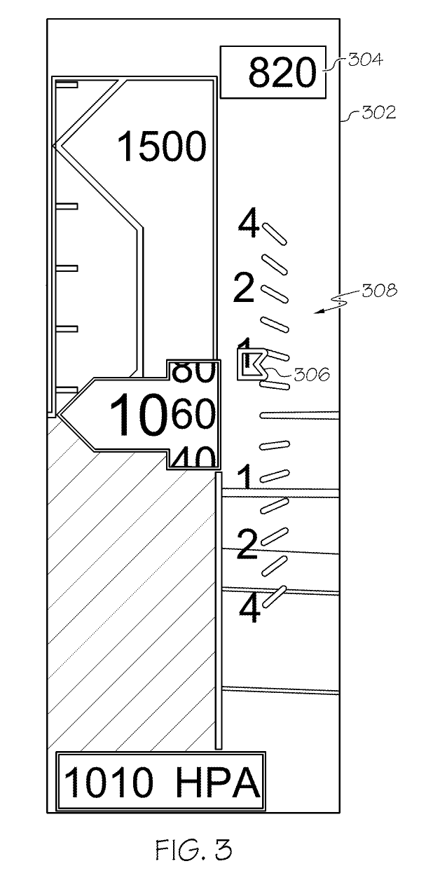

FIG. 3 is a graphical representation of an altimeter 300 and a vertical speed indicator 302. As can be seen, the altimeter 300 indicates that the aircraft is sitting on the ground at roughly 1,060 feet above sea level. The rate-of-climb determined in accordance with the previous description (e.g. 820 ft/min) is displayed at digital readout 304 and/or as a bug 306 on the vertical speed scale 308.

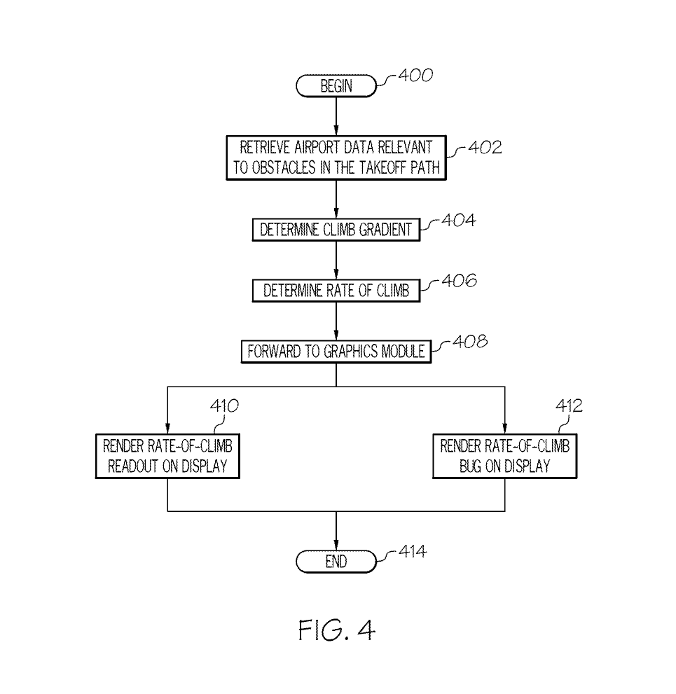

FIG. 4 is a flow chart illustrating a method 400 for displaying the rate-of-climb necessary to clear an obstacle in the departure path of an aircraft prior to takeoff. In STEP 402, airport data relating to the obstacle is retrieved from one or more data sources as described previously in connection with FIG. 1. Next, the obstacle data is utilized to determine the respective climb gradient (STEP 404). This may be accomplished with the use of a TOLD system as above described. Using the climb gradient, a processor determines the rate-of-climb (STEP 406). This is forwarded to a graphics module (131 in FIG. 1) that renders on a display 106 (e.g. the vertical speed indicator) a digital readout of the rate-of-climb and/or a rate-of-climb bug (STEPS 410 and 412) respectively.

Thus, there has been provided a system and method for displaying a rate-of-climb on, for example, a vertical speed indicator of a primary flight display during the takeoff phase of a flight that is necessary to avoid an obstacle in the departure path of the aircraft. This reduces pilot workload by eliminating the need to refer to various charts and tables and then calculating the rate-of-climb.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method for enhancing situational awareness onboard an aircraft during takeoff procedure comprising:
receiving real time terrain sensor data of a ground obstacle;
rendering on a display a rate-of-climb configured to avoid the ground obstacle in the takeoff path of the aircraft based in part on the real time sensor data.

2. The method according to claim 1 further comprising rendering the rate-of-climb on a vertical speed indicator.

3. The method of claim 2 further comprising rendering the rate-of-climb as a digital readout.

4. The method of claim 2 further comprising rendering the rate-of-climb as a bug.

5. The method of claim 2 further comprising determining a climb gradient.

6. The method of claim 5 wherein the climb gradient is determined by a TOLD system.

7. The method of claim 6 further comprising determining the rate-of-climb in feet-per-minute.

8. The method of claim 7 further comprising retrieving airport data relevant to obstacles in the aircraft's departure path.

9. A flight-deck display system, comprising:
a source of data related to a ground obstacle in an aircraft's departure path;
a display system; and
a processor coupled to the source of data and to the display system and configured to render on the display a rate-of-climb configured to avoid the ground obstacle.

10. The system of claim 9 wherein the display system comprises a vertical speed indicator.

11. The system of claim 9 further comprising a graphics module coupled to the display system and to the processor for render the rate-of-climb on the display.

12. The system of claim 11 wherein the graphics module renders the rate-of-climb on the display as a digital readout.

13. The system of claim 11 wherein the graphics module renders the rate-of-climb as a bug.

14. The system of claim 12 further comprising a TOLD system for determining a climb gradient.

15. The system of claim 14 wherein the processor is further configured to determine the rate-of-climb from the climb gradient.

16. A method for providing an aircraft with adequate clearance over a ground obstacle in the aircraft's takeoff departure path, comprising:
determining in a processor the correct rate-of-climb to clear the ground obstacle; and
rendering the rate-of-climb on a display for viewing prior to takeoff.

17. The method of claim 16 wherein the step of rendering comprises graphically representing a digital readout on the display.

18. The method of claim 17 wherein the step of rendering comprises graphically displaying a digital readout on a vertical speed indicator.

19. The method of claim 18 wherein the step of rendering comprises graphically displaying a bug on the vertical speed indicator.

20. The method of claim 19 wherein the rate-of-climb is derived from a climb gradient determined by a TOLD system.
